(19) United States
(12) Patent Application Publication
(10) Pub. No.: US 2004/0136539 A1
(43) Pub. Date: Jul. 15, 2004

(54) Audio-conditioned acoustics-based diagnostics

(76) Inventors: William Walter Uhi, Boise, ID (US); James P. Terry, Garden Valley, ID (US); James R. Nelson, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/339,445

(22) Filed: Jan. 9, 2003

(51) Int. Cl. H04R 29/00

(52) U.S. Cl. 381/56; 381/59

(57) ABSTRACT

Described herein is a technology for facilitating diagnosis of the operation of devices or machines based, at least in part, upon the acoustics of such.

### BACKGROUND

In the life of each machine with moving parts, the day comes when parts wear or fail. When that day comes, someone must fix or replace the worn or failed parts. Otherwise, the useful life of that machine is over. The cause of the fault needs to be identified for the machine to continue its serviceable life.

This is true for wide range of devices and machines with moving parts and/or consumables. For example, it is true for engines, scanners, cranes, pencil sharpeners, trucks, ships, transmissions, vending machines, printers, jukeboxes, elevators, air conditioners, fax machines, pumps, trains, photocopiers, and on and on.

### Abnormal Operation

Herein, abnormal operation refers to the operation of a device or machine that is not consistent with its regular, productive, and useful functions. Particularly, these functions are those that are consistent with effective performance. With the brakes of an automobile, for example, the sound of metal grinding on metal probably indicates an abnormal operation. While the brakes are still operational and functional, their function is hampered. The noise indicates its abnormal operation.

For simplicity, this discussion focuses on the abnormal operation with office machinery. More particularly, it focuses on the printers typically found in the office or home environments, such as laser or ink-jet printers.

### Troubleshooting Abnormal Printer Operation

A typical troubleshooting scenario for a printer includes a customer calling a technical support center for help. The customer describes the issue to the technician over the telephone. It is technician's goal to solve the problem; however, it is typical that she only has the information gleaned from the customer's observations and interpretations.

For example, the customer may describe the condition as a “paper jam.” Frequently, the technician asks when the jam occurs during the printer operation. Typically, the technician receives answers much like this example: “it feeds a little ways and then it starts crinkling the paper.” Therefore, the technician must rely on the customer's observations and interpretations of the printer operation.

Consequently, remote troubleshooting between the customer and technician may fail to find the cause of the trouble as efficiently or effectively as desired. Therefore, an on-site troubleshooting visit may be necessitated.

Since a field technician can directly observe the abnormal printer operation, an on-site visit frequently results in extremely efficient and quick solutions for the trouble. However, an on-site visit can be quite costly compared to remote troubleshooting. On-site visits include significant overhead, such as travel, labor-costs, training, and equipment.

There are significant drawbacks to this dual-tiered troubleshooting approach (of remote and then on-site). Some of those drawbacks include:

cost of on-site visits;

cost of field and remote technicians;

cost of training field and remote technicians;

scarceness of trained field and remote technicians.

When under warranty, the manufacturer bears the burden of some or all of the time and expense of troubleshooting (including on-site visits). Even after the warranty expires, reducing the need for troubleshooting (especially on-site visits) reduces overall operating and overhead costs. It frees up resources for other tasks.

### Some of the Drawbacks to Conventional Troubleshooting

With conventional troubleshooting, the remote technician typically relies on the observations and interpretations of a local untrained observer. While less expensive than on-site visits, conventional remote troubleshooting is less effective and efficient (with regard to problem solving) than having an on-site expert (e.g., a field technician).

### SUMMARY

Described herein is a technology for facilitating diagnosis of the operation of devices or machines based, at least in part, upon the acoustics of such.

In one embodiment, the invention may comprise a system facilitating acoustics-based diagnosis, the system comprising a sound-gatherer configured to gather sound from a device to produce a sound-representative signal; a sound-signal-conditioner configured to produce a conditioned sound-representative signal by shifting a first range of frequencies of the sound-representative signal that are outside a defined bandwidth to a different corresponding second range of frequencies that are within that defined bandwidth; a sound-producer configured to produce audio sound based upon the conditioned sound-representative signal, wherein the produced audio sound has frequencies within the defined bandwidth.

In another embodiment, the invention may comprise method facilitating acoustics-based diagnosis, the method comprising: gathering sound from a device and producing a signal representative of the gathered sound; conditioning the signal representative of the gathered sound by shifting a first range of frequencies of the sound-representative signal that are outside a defined bandwidth to a different corresponding second range of frequencies that are within that defined bandwidth; producing audio sound based upon the conditioned sound-representative signal resulting from the conditioning, wherein the produced audio sound has frequencies within the defined bandwidth.

In yet another embodiment, the invention may comprise a computer-readable medium having computer-executable instructions that, when executed by a computer, performs a method for facilitating acoustics-based diagnosis, the method comprising: obtaining a signal representative of a conditioned sound, wherein its frequencies fall within a defined sound bandwidth; de-conditioning the signal representative of a conditioned sound so that frequencies within the defined sound bandwidth are shifted outside of that bandwidth; acquiring one or more acoustics-based fault-signatures associated with the device; analyzing the de-conditioned sound-representative signal based upon the one or more acquired fault-signatures.

In a further embodiment, the invention may comprise a method for facilitating acoustics-based diagnosis, the method comprising: obtaining a signal representative of a conditioned sound, wherein its frequencies fall within a defined sound bandwidth; de-conditioning the signal representative of a conditioned sound so that frequencies outside the defined sound bandwidth are shifted inside of that bandwidth; acquiring one or more acoustics-based fault-signatures associated with the device; analyzing the de-conditioned sound-representative signal based upon the one or more acquired fault-signatures.

In still another embodiment, the invention may comprise an acoustics-based diagnostics architecture comprising: a sound-gatherer configured to gather sound produced by the operation of a device and convert the gathered sound into a sound-representative signal; a sound-signal-conditioner configured to produce a conditioned sound-representative signal by shifting a first range of frequencies of the sound-representative signal that are outside a defined bandwidth to a different corresponding second range of frequencies that are within that defined bandwidth; a sound-deconditioner configured to de-condition the signal representative of a conditioned sound so that frequencies outside the defined sound bandwidth are shifted inside of that bandwidth; a sound-analyzer configured to analyze the signal representative of the de-conditioned sound and determine likelihood of one or more fault conditions of the device; a fault-signature database interface configured to interface and acquire one or more fault-signatures associated with the device from a database of such; wherein the analysis of the signal representative of the de-conditioned sound by the sound-analyzer is based upon the one or more fault-signatures acquired from the database.

### BRIEF DESCRIPTION OF THE DRAWINGS

The same numbers are used throughout the drawings to reference like elements and features.

FIG. 1 schematically illustrates a remote diagnosis.

FIG. 2 is a diagram illustrating components of an audio conditioning unit.

FIG. 3 is a schematic diagram showing audio conditioning module components of the audio conditioning unit of FIG. 2.

FIG. 4 is a block diagram illustrating components of an acoustic analyzer at a call center.

FIG. 5 is a flow diagram showing an analytic method for detecting a fault condition.

FIG. 6 is a schematic illustration of a printer architecture.

FIG. 7 is a schematic illustration of a computing device.

### DETAILED DESCRIPTION

The following description sets forth one or more exemplary implementations of an audio-conditioned acoustics-based diagnostics. The inventors intend these exemplary implementations to be examples. The inventors do not intend these exemplary implementations to limit the scope of the claimed present invention. Rather, the inventors have contemplated that the claimed present invention might also be embodied and implemented in other ways, in conjunction with other present or future technologies.

An example of an embodiment of an audio-conditioned acoustics-based diagnostics may be referred to as an “exemplary diagnostics.”

### Introduction

For convenience and clarity of explanation, the bulk of the description herein focuses on office machinery and computer peripherals. Two common examples are printers and scanners. Therefore, the terms “office machinery”, “computer peripheral”, or “peripheral” expressly includes printers and scanners along with other devices that are not listed, but are similar in nature.

However, unless the context clearly indicates otherwise, the discussion herein applies to all devices and machines that produce sounds-especially, when such sound represents an abnormal operating condition. Common office machines fit into this classification. For example, printers, scanners, computer peripherals, photocopiers, facsimile machines, computers, etc. Therefore, the term “office machine” expressly includes these devices listed here along with others that are not listed, but are similar in nature.

By way of example only and not limitation, this is a list of other such devices and machinery that fit into this classification of those that produce sounds especially, when such sound represents an abnormal operating condition:

audio components;

electronics;

engines.

In addition, unless the context indicates otherwise, the term “sound,” as used herein, includes both audible and inaudible sounds. In other words, “sounds” includes sounds that are audible to humans, and sounds that are below the human audible range (i.e., subsonic), and sounds that are above the human audible range (i.e., ultrasonic).

### Exemplary Acoustics-based Remote Diagnosis Architecture

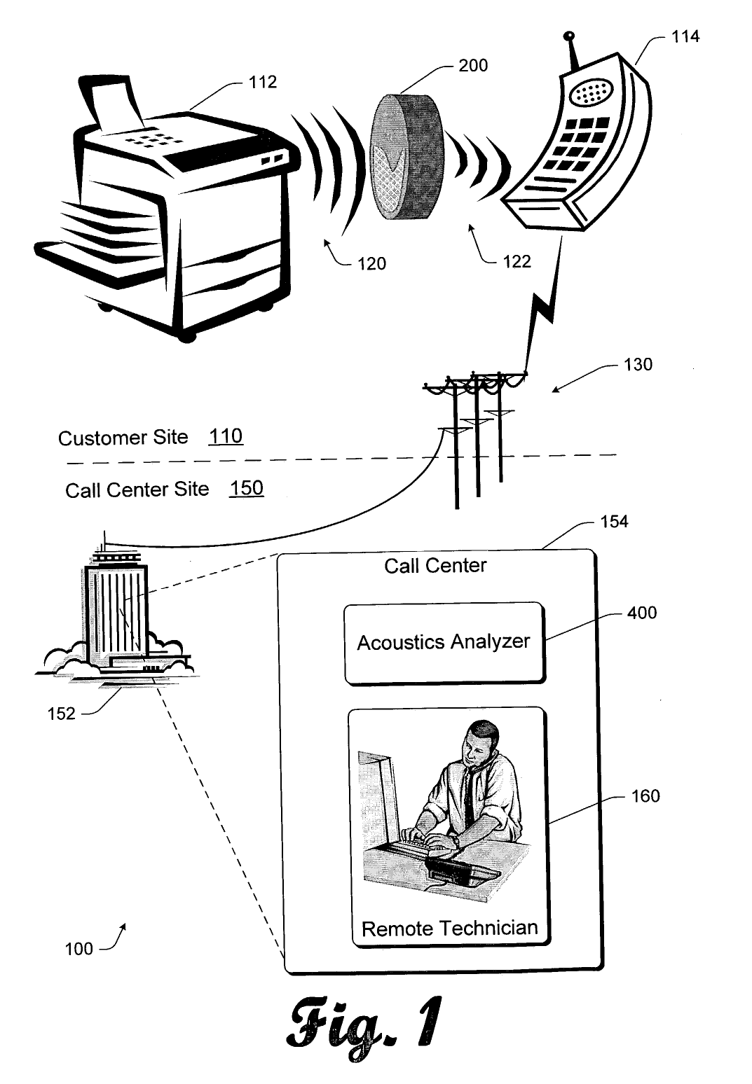

FIG. 1 illustrates an acoustics-based remote diagnosis architecture 100. It includes two sites that are likely remote from each other: customer site 110 and call center site 150. These site names are used for convenience and as examples. They are, of course, not intended to be limiting. Herein, the term “remote” refers to separation by time and/or space.

Using the acoustics-based remote diagnosis architecture 100, one may automatically diagnose abnormal operation of a printer based upon the sounds of such operation. In other words, it is based upon the acoustics of the abnormal operation. Alternatively, it may facilitate a manual diagnosis of the abnormal operation.

When a customer encounters a problem with their printer 112, she typically calls technical support. With conventional approaches, the remote technician (e.g., technician 160) is limited to the customer's observations and interpretations. Now, with the exemplary diagnostics, the remote technician may actually hear the printer's abnormal operation. Alternatively, the sound is automatically analyzed and the results of such automatic analysis are provided to the technician.

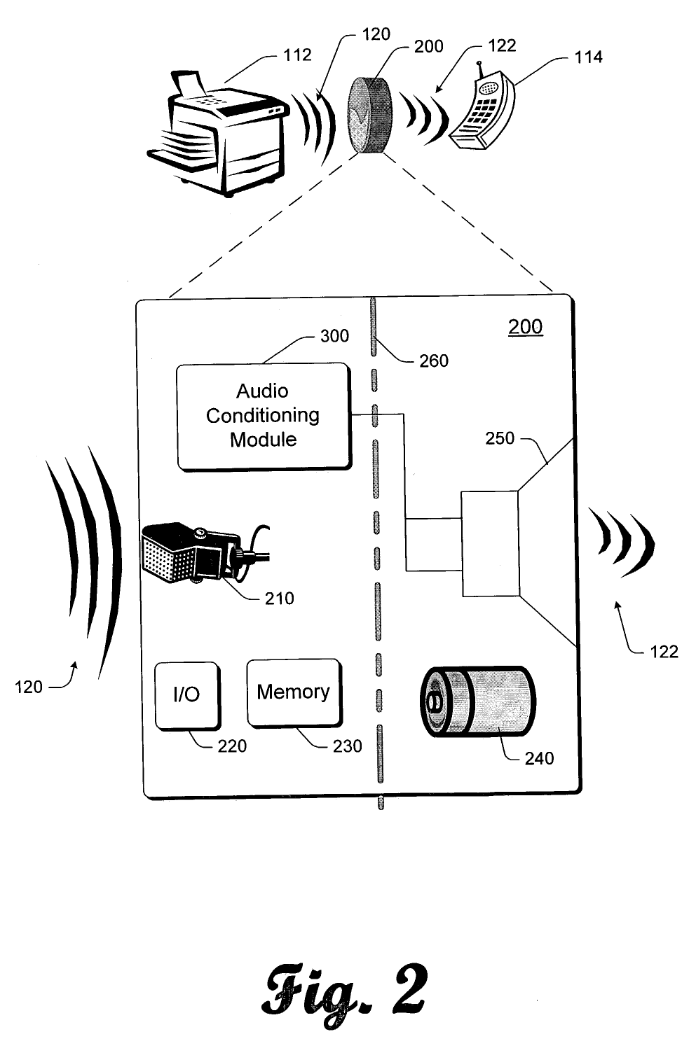

Within this acoustics-based remote diagnosis architecture 100, an audio conditioning unit 200 of FIG. 2 is employed to capture a wide spectrum of the sound emitted by a printer during its abnormal operation. Furthermore, it reproduces the captured sound spectrum, but within a narrowly defined band of frequencies.

The customer site 110 includes the subject office machinery, namely a printer 112. When it operates abnormally, that printer emits a sound 120. When the audio conditioning unit 200 is placed near the printer 112, it receives and processes the sound 120. It emits a new sound, which is a conditioned specimen 122 of the sound 120. This conditioned specimen 122 is received by a phone 114 for transmission over a telephonic network infrastructure 130.

Typically, the call from the customer site 110 over the telephone network infrastructure 130 is to the call center site 150. Building 152 represents the building or location of the call center site. The call center 154 itself may be housed in a building 154.

The call center 154 includes two components: The acoustics analyzer 400 and/or the remote technician 160. The acoustic analyzer 400 receives electronic signal of the conditioned specimen 122 as it is transmitted over the telephonic network infrastructure 130. It reproduces the specimen from its transmission signal. The acoustic analyzer 400 de-conditions the specimen to reproduce all or part of the original sound 120.

The acoustic analyzer 400 analyzes that sound to automatically diagnose an abnormal operation based upon the acoustics of the abnormal operation and/or to facilitate manual diagnosis of the sound. The remote technician 160 interprets the results of the analysis and/or performs this own analysis, and then communicates with the customer.

### Conditioning the Sound

The telephonic network-infrastructure 130 carries signals representative of sound. Herein, such a signal is called a sound-representative signal.

However, the telephonic network infrastructure 130 only carries signals within a limited bandwidth. The frequencies transmitted are limited to a bandwidth of about 3,000 hertz. None of signal frequencies below about 400 hertz and above about 3,400 hertz is transmitted across a typical telephonic network infrastructure.

The audio conditioning unit 200 conditions the sound 120 so that when it is transmitted over the infrastructure 130, the frequencies of its sound-representative signal fall within the typically telephone transmission spectrum. The conditioned sound 122 now includes sounds that had unconditioned frequencies that would have been outside the telephone transmission spectrum. Consequently, conditioning allows for sounds higher/lower (ultra-/sub-) than the telephone transmission spectrum to be transmitted via sound-representative signals over that infrastructure.

A audio conditioning may also be used to provide a “cleaner” signal in the low frequency audio spectrum where machine “rumblings” occur.

### Audio Conditioning Unit

As shown in FIGS. 1 and 2, the audio conditioning unit 200 may be a portable device, which in the exemplary embodiment includes a circular, hockey-puck-like casing. The audio conditioning unit 200 houses some of the components of the acoustics-based remote diagnosis architecture 100. This is an example of one implementation. However, the unit may have most any other sized and shaped casing.

This sort of portable device is convenient for users or field technicians to use to troubleshoot a printer's abnormal operation. Much as is illustrated in FIGS. 1 and 2, this device may be literally placed between the printer 112 and the telephone receiver 114. Alternatively, the audio conditioning unit 200 may be a device that is temporarily or permanently coupled to the printer.

Furthermore, one or more of the components of the audio conditioning unit 200 may be integrated into the printer itself.

As shown in FIG. 2, the audio conditioning unit 200 includes a microphone 210 for gathering sound 120. This may be, for example, a contact microphone or vibration transducer. This microphone and its associated components (or other devices that perform a sound gathering function) are also referred to herein as a sound-gatherer.

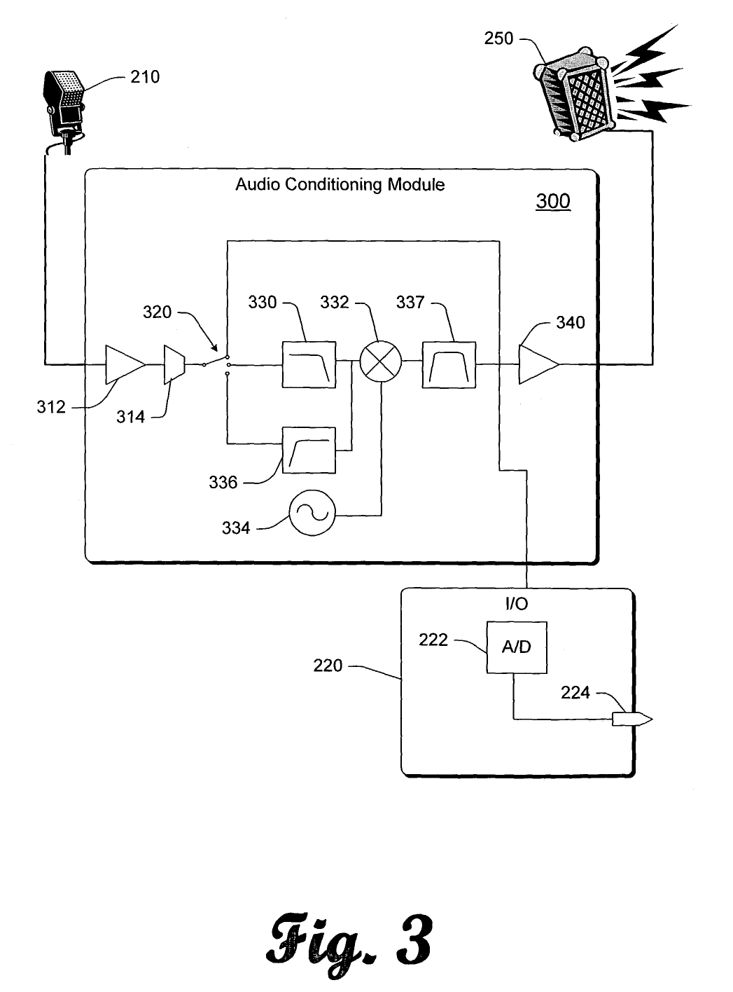

The unit includes audio conditioning module 300 for processing the incoming sound 120. The audio conditioning module 300 is described in the section below focusing on FIG. 3. This audio conditioning module 300 and its associated components (or other devices that perform an audio conditioning function) are also referred to herein as an audio-conditioner or a sound-signal condtioner.

Furthermore, the unit includes an Input/Output (I/O) system 220 for connecting to external digital devices (such as computers). It may also include a memory 230 for storing sound representations for later playback or transmission. It includes an internal power source 240, such as a battery. Alternatively, it may include a connection to an external power source.

Moreover, the audio conditioning unit 200 also includes a speaker 250 for generating the conditioned sound 122 based upon the output of the conditioning module 300. This speaker and its associated components (or other devices that perform a sound producing function) are also referred to herein as a sound-producer.

The unit 200 may be constructed with acoustically dampening materials to prevent audio feedback and stray noise pick-up. The unit, for example, may include an acoustically dampening wall 260 between the sound-gathering portion (with microphone 210) and sound-producing portion (with speaker 250).

Although the microphone 210 will be located within hearing distance of the subject printer 112, nearly all of the other components of the acoustics-based remote diagnosis architecture 100 may be located remotely from the printer.

### Exemplary Use of the Audio Conditioning Unit

In the embodiment illustrated in FIGS. 1 and 2, the microphone 210 of the audio conditioning unit 200 is placed against the device under test (e.g., the printer 112). A telephone microphone 114 is placed against the opposite side of the unit.

Machine vibrations (e.g., sound 120) are picked up by the microphone 210. The microphone converts this into a sound-representative signal. The audio conditioning module 300 amplifies the sound-representative signal, enhances the low and/or high frequencies, mixes the result with a carrier frequency for better transmission, filters high and/or low frequencies, amplifies again, and outputs to the speaker 250. The speaker converts the conditioned sound-representative signal into actual sound.

The speaker 250 may be placed near (e.g., pressed against) the telephone 114 for transmission to a remote site (e.g., call center 154) where the spectral analysis takes place. Therefore, the telephone receives the conditioned sound and converts it into a sound-representative signal. Optionally, the output may be fed to a PDA or laptop computer (via I/O system 220) near the device for onsite analysis of the sound-representative signal.

### Audio Conditioning Module

FIG. 3 shows details of one exemplary embodiment of the audio conditioning module 300 and details of the I/O system 220.

The module 300 may be an electronic circuit constructed in a manner illustrated in FIG. 3. It receives a sound-representative signal from the microphone 210. The module 300 includes an audio pre-amp 312 to amplify the original sound-representative signal (which is representative of sound 120) and an audio compressor 314.

The module 300 may include a selector switch 320 that routes the signal to a low-pass filter, a high-pass filter, or a by-pass line. It may also include a low-pass filter 330 or a high-pass filter 336 to select the preferred range of frequencies to be mixed and transmitted from the sound-representative signal. It has a mixer 332 to add the selected frequencies to a local oscillator 334, which provides a carrier signal (e.g., around 2000 Hz) for the frequencies.

The module 300 may have a band-pass filter 337 to select the final conditioned frequency range eliminating extraneous high and low frequencies. Alternatively, the module may use other combinations of filters and switches to condition for different bandwidths. With the switch in the by-pass position, the amplified and compressed signal may be routed without any filtering and mixing.

The conditioned signal is amplified with PA amp 340 and the speaker 250 produces sound based upon the conditioned signal accordingly. This sound is the conditioned sound.

FIG. 3 shows the I/O system 220 for connecting to external digital devices (such as computers). The I/O system includes an analog-to-digital (A/D) converter 222 to convert the conditioned signal into a digital representation. The representation may be transmitted via an I/O port 224 to other devices (such as computers).

Alternatively, the digitized conditioned signal is stored in memory 230.

### Acoustics Analyzer

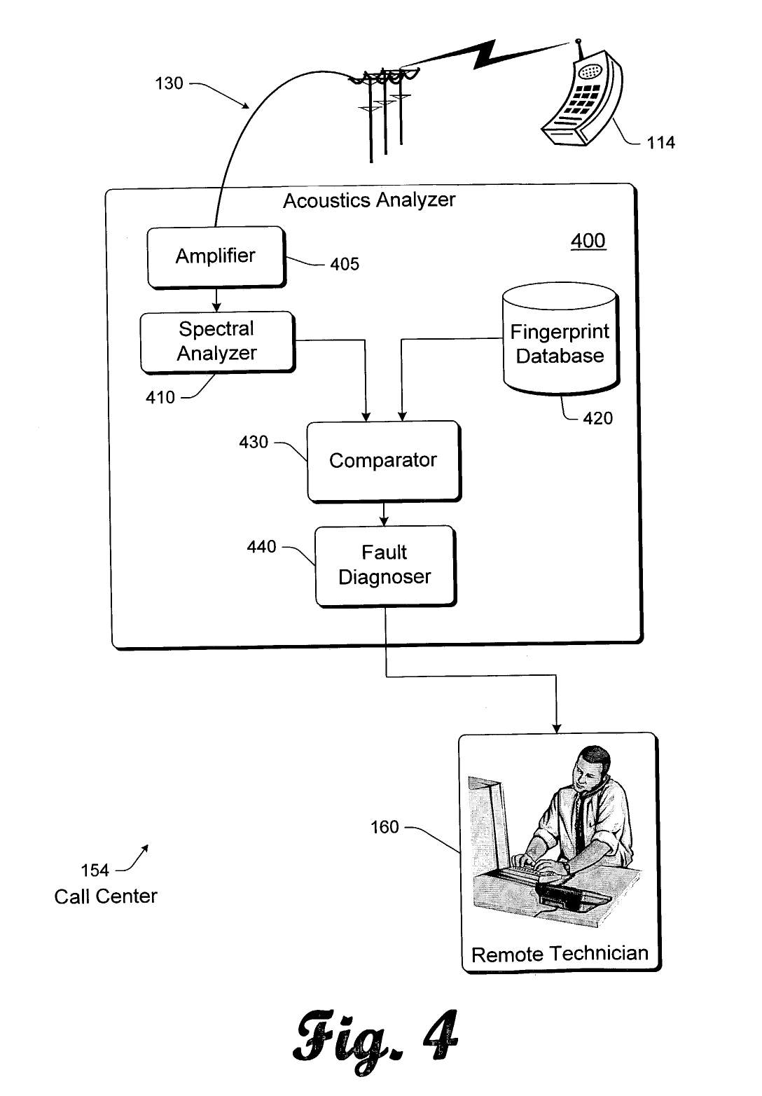

FIG. 4 shows the acoustics analyzer 400 of the call center 154. The telephone 114 sends a signal representative of the conditioned sound over the telephone network infrastructure 130 to the call center 154. The acoustics analyzer 400 receives this input sound-representative signal. With at least one implementation, the acoustics analyzer 400 is a personal computer with one or more program modules for acoustics analysis.

The acoustics analyzer 400 has an audio input via a telephone connection or microphone to a digitizer or PC sound card. It includes a amplifier 405 which amplifies the input signal representative of the conditioned sound. The amplifier may be implemented via hardware, software, or some combination of both. The amplifier 405 and its associated components (or other devices that perform a signal amplification function) are also referred to herein as a sound-signal deconditioner.

The acoustics analyzer 400 has a spectral analyzer 410. This may include an audio spectral analysis routine (e.g., FFT routine—Fast Fourier Transform). The analyzer 400 has a database 420 of fault spectral “fingerprint” (or “signatures”) for the specific type of device under test. These are stored wave forms or data representative of sounds emitted during known fault conditions.

The acoustics analyzer 400 may process the amplified input sound-representative signal using zero-crossing time-sliced FFT (Fast Fourier Transform) at predetermined intervals to analyze printer noise. For example, it might use 100 msec time slices.

An error analysis routine of the analyzer 400 compares the analyzed input sound to the entries in the database 420. The acoustic analyzer 400 may be an output routine to display of the results. These functions are performed by a comparator 430 and/or a fault diagnoser 440.

This output may be presented to a remote technician 160. This technician may simply report the results of the diagnosis to the customer. Alternatively, this technician may further analyze the analyzer 400 results and make additional conclusions. The technician will report those conclusions to the customer.

In another alternative embodiment, the technician 160 listens to the same input sound as the analyzer 400 does (conditioned and/or de-conditioned) to draw her own conclusions. This human conclusion can be used in conjunction with the results of the acoustics analyzer 400. Comparing a human diagnosis to the diagnosis of the acoustic analyzer 400 may be used for training technicians. It may also be used to fine-tune the acoustics analyzer 400.

### Operational Overview of the Acoustic Analyzer

The acoustical analyzer splits the amplified sound-representative signal into a series of spectral signatures for specifically known machine conditions. Spectral matches are recorded as a “percent of perfect match” for a specific signature. This match file is mapped to a look-up table of machine failures, warning, error conditions, and suggested maintenance procedures. The tabular result is summarized and displayed to the technician 160 for action.

Alternatively, the system could be filly automated and the results sent to the customer via e-mail or voice-response unit.

### Predictive Preventive Maintenance

In addition to diagnosing present abnormal operating conditions of the printer, the exemplary diagnostics may predict the onset of an abnormal condition in the near future. While the printer appears to be operating normally, it may emit telltale sounds that indicate a need for maintenance or repair in the near future. For example, a small squeak from a gear may indicate that it will need replacement within two-three months.

With the exemplary diagnostics, preventive maintenance may be effectively performed from the failure prediction based upon the sounds the printer is emitting. This will help reduce downtime by allowing user to schedule maintenance on issues before they occur.

### Database

Each problem condition (“fault”) will typically have a unique audio signature (“fault signature”). Each predictive problem condition will also typically have its own unique audio signature (“predictive fault signature”). These fault signatures can be determined empirically and with a dose of heuristics. In other words, a series of numerous experiments (or field tests) are performed on each subject device to record the sounds of various fault and predictive-fault conditions. The automatic troubleshooting using these fault signatures may be refined based upon the experience and knowledge of expert technicians

Such fault signatures may be categorized and associated in a relational database. Diagnostic algorithms compare noise signals to one or more fault signatures to draw conclusions regarding the existence of one or more current or future problem condition(s).

### Time Delayed Analysis of Abnormal Operational Sounds

In another implementation of the exemplary diagnostics, the sounds of the printer may be recorded. That recording may be stored. It may be transmitted or delivered to a sound processing center.

With this implementation, the operational sounds of the printer are manually or automatically recorded (e.g., MP3 format). This sound file may be processed by a computer linked to the printer. Alternatively, this sound file may be transmitted (e.g., via email) to a remote sound processing center.

Since traditional digital audio formats (e.g., MP3) are optimized in the human audible range, conditioning the signal before storing in that format captures a greater bandwidth.

### Methodological Implementation of the Exemplary Diagnostics

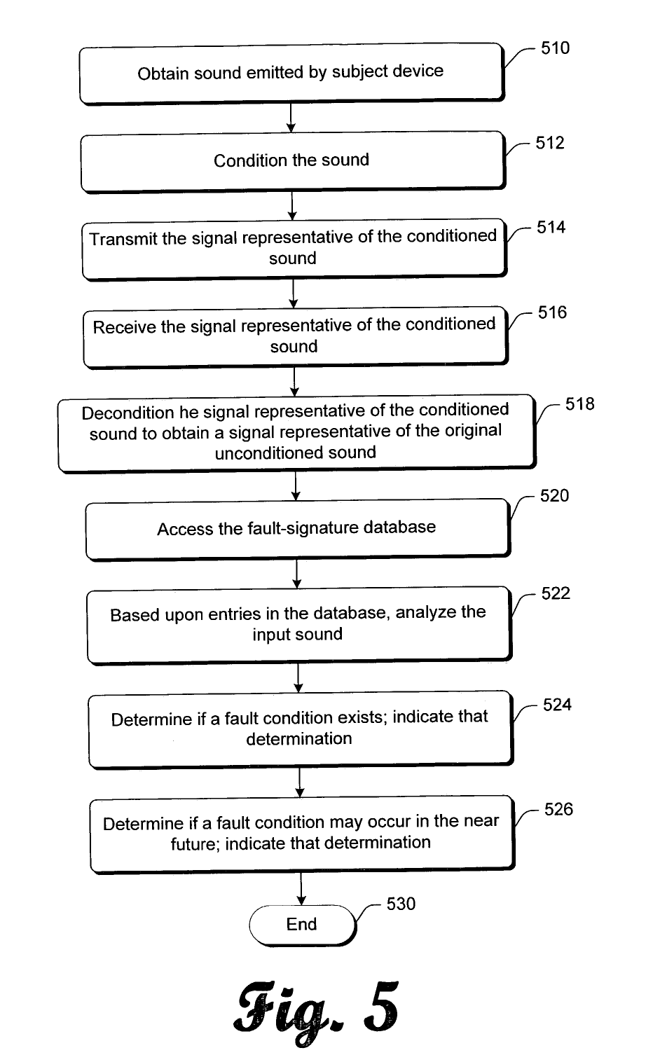

FIG. 5 shows a methodological implementation of the exemplary diagnostics performed by the acoustics-based remote diagnosis architecture 100 (or some portion thereof). This methodological implementation may be performed in software, hardware, or a combination thereof.

At 510 of FIG. 5, the exemplary diagnostics obtains sound emitted by a subject device. Herein, the primary example of a subject device is a printer, but it may be any devices or machine that produces sounds-especially, when such sound represents an abnormal operating condition.

At 512, the inputted sound is conditioned. At 514, a signal representative of that conditioned sound is transmitted over the telephone network infrastructure 130.

At 516 of FIG. 5, the exemplary diagnostics receives the signal representative of that conditioned sound. At 518, it de-conditions (e.g., by signal amplification) the signal representative of that conditioned sound to get a signal representative of the original unconditioned sound.

At 520, the exemplary diagnostics accesses data in a fault-signature database. This database may include fault-signatures of both current faults and predictive faults. The database 420 is the primary example of a component that the exemplary diagnostics may employ to store the signatures.

At 522, the exemplary diagnostics analyzes the input sound using one or more fault signatures acquired from the database. Based upon such analysis, it determines whether a current fault condition exists and what that condition is. Alternatively, it may just present a report with likelihoods of particular faults. At 524, it indicates the result of that determination. It may indicate it to the remote technician.

The exemplary diagnostics may optionally determine whether a future fault condition exists and what that condition is. Alternatively, it may just present a report with likelihoods of particular faults. At 526, it indicates the result of that determination. It may indicate it to the remote technician.

The process ends at 530.

### Exemplary Printer Architecture

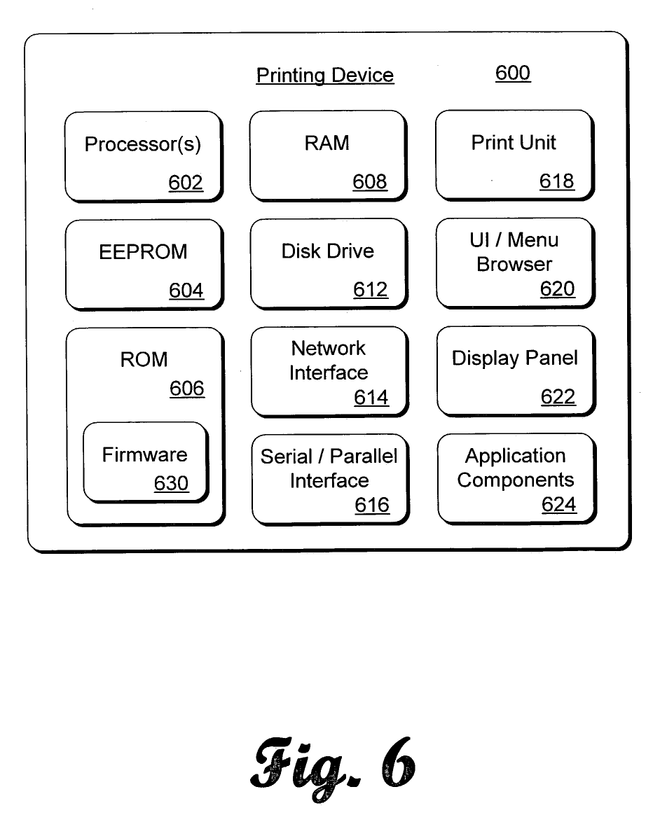

FIG. 6 illustrates various components of an exemplary printing device 600 that can be utilized the exemplary diagnostics.

Printer 600 includes one or more processors 602, an electrically erasable programmable read-only memory (EEPROM) 604, ROM 606 (non-erasable), and a random access memory (RAM) 608. Although printer 600 is illustrated having an EEPROM 604 and ROM 606, a particular printer may only include one of the memory components. Additionally, although not shown, a system bus typically connects the various components within the printing device 600.

The printer 600 also has a firmware component 610 that is implemented as a permanent memory module stored on ROM 606. The firmware 610 is programmed and tested like software, and is distributed with the printer 600. The firmware 610 can be implemented to coordinate operations of the hardware within printer 600 and contains programming constructs used to perform such operations.

Processor(s) 602 process various instructions to control the operation of the printer 600 and to communicate with other electronic and computing devices. The memory components, EEPROM 604, ROM 606, and RAM 608, store various information and/or data such as configuration information, fonts, templates, data being printed, and menu structure information. Although not shown, a particular printer can also include a flash memory device in place of or in addition to EEPROM 604 and ROM 606.

Printer 600 also includes a disk drive 612, a network interface 614, and a serial/parallel interface 616. Disk drive 612 provides additional storage for data being printed or other information maintained by the printer 600. Although printer 600 is illustrated having both RAM 608 and a disk drive 612, a particular printer may include either RAM 608 or disk drive 612, depending on the storage needs of the printer. For example, an inexpensive printer may include a small amount of RAM 608 and no disk drive 612, thereby reducing the manufacturing cost of the printer.

Network interface 614 provides a connection between printer 600 and a data communication network. The network interface 614 allows devices coupled to a common data communication network to send print jobs, menu data, and other information to printer 600 via the network. Similarly, serial/parallel interface 616 provides a data communication path directly between printer 600 and another electronic or computing device. Although printer 600 is illustrated having a network interface 614 and serial/parallel interface 616, a particular printer may only include one interface component.

Printer 600 also includes a print unit 618 that includes mechanisms arranged to selectively apply ink (e.g., liquid ink, toner, etc.) to a print media such as paper, plastic, fabric, and the like in accordance with print data corresponding to a print job. For example, print unit 618 can include a conventional laser printing mechanism that selectively causes toner to be applied to an intermediate surface of a drum or belt. The intermediate surface can then be brought within close proximity of a print media in a manner that causes the toner to be transferred to the print media in a controlled fashion. The toner on the print media can then be more permanently fixed to the print media, for example, by selectively applying thermal energy to the toner.

Print unit 618 can also be configured to support duplex printing, for example, by selectively flipping or turning the print media as required to print on both sides. Those skilled in the art will recognize that there are many different types of print units available, and that for the purposes of the present invention, print unit 618 can include any of these different types.

Printer 600 also includes a user interface and menu browser 620, and a display panel 622. The user interface and menu browser 620 allows a user of the printer 600 to navigate the printer's menu structure. User interface 620 can be indicators or a series of buttons, switches, or other selectable controls that are manipulated by a user of the printer. Display panel 622 is a graphical display that provides information regarding the status of the printer 600 and the current options available to a user through the menu structure.

Printer 600 can, and typically does, include application components 624 that provide a runtime environment in which software applications or applets can run or execute. One exemplary runtime environment is a Java Virtual Machine (JVM). Those skilled in the art will recognize that there are many different types of runtime environments available. A runtime environment facilitates the extensibility of printer 600 by allowing various interfaces to be defined that, in turn, allow the application components 624 to interact with the printer.

### Exemplary Computer Architecture

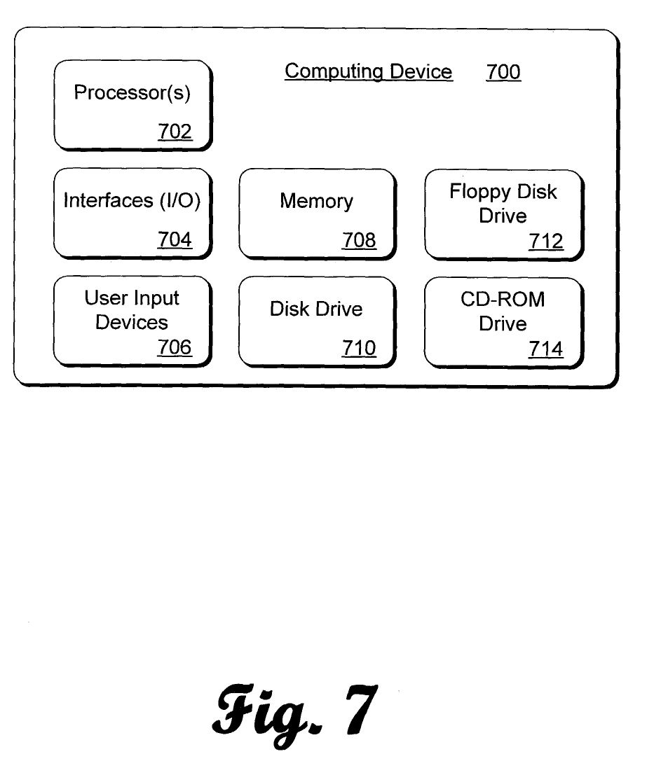

FIG. 7 illustrates various components of an exemplary computing device 700 that can be utilized to implement the exemplary diagnostics.

Computer 700 includes one or more processors 702, interfaces 704 for inputting and outputting data, and user input devices 706. Processor(s) 702 process various instructions to control the operation of computer 700, while interfaces 704 provide a mechanism for computer 700 to communicate with other electronic and computing devices. User input devices 706 include a keyboard, mouse, pointing device, or other mechanisms for interacting with, and inputting information to computer 700.

Computer 700 also includes a memory 708 (such as ROM and/or RAM), a disk drive 710, a floppy disk drive 712, and a CD-ROM drive 714. Memory 708, disk drive 710, floppy disk drive 712, and CD-ROM drive 714 provide data storage mechanisms for computer 700. Although not shown, a system bus typically connects the various components within the computing device 700.

1. A system facilitating acoustics-based diagnosis, the system comprising:
a sound-gatherer configured to gather sound from a device to produce a sound-representative signal;
a sound-signal-conditioner configured to produce a conditioned sound-representative signal by shifting a first range of frequencies of the sound-representative signal that are outside a defined bandwidth to a different corresponding second range of frequencies that are within that defined bandwidth;
a sound-producer configured to produce audio sound based upon the conditioned sound-representative signal, wherein the produced audio sound has frequencies within the defined bandwidth.

2. A system as recited in claim 1, wherein the defined sound bandwidth is within the human hearing range.

3. A system as recited in claim 1, wherein the defined sound bandwidth is a range of sound-representative signals typically transmitted over the telephonic network infrastructure.

4. A system as recited in claim 1, wherein the first range of frequencies is below approximately 400 Hz.

5. A system as recited in claim 1, wherein the first range of frequencies is above approximately 3400 Hz.

6. A system as recited in claim 1, wherein the first range of frequencies is below the second range.

7. A system as recited in claim 1, wherein the first range of frequencies is above the second range.

8. A system as recited in claim 1, wherein the sound-gatherer is selected from a group consisting of a microphone, a contact microphone, and a vibration transducer.

9. A system as recited in claim 1 further comprising a digital sound storer configured to digitize the conditioned sound and store it in a storage medium.

10. A system as recited in claim 1, wherein the audio-conditioner is selected from a group consisting of an integrated circuit, electronic components, ASIC, and a software module.

11. A system as recited in claim 1, wherein the audio-conditioner is further configured to:
enhance the low frequencies of the sound-representative signal which is representative of the gathered sound;
mix the enhanced low frequencies with a carrier frequency;
filter the frequencies of the mixed signal; and
output the filtered mixed signal to the sound-producer.

12. A system as recited in claim 1, wherein the audio-conditioner is further configured to:
enhance the high frequencies of the sound-representative signal which is representative of the gathered sound;
mix the enhanced high frequencies with a carrier frequency;
filter the frequencies of the mixed signal; and
output the filtered mixed signal to the sound-producer.

13. A mechanical device comprising:
one or more components that produce sound;
the system as recited in claim 1.

14. An office machine comprising:
one or more components that produce sound;
the system as recited in claim 1.

15. A method facilitating acoustics-based diagnosis, the method comprising:
gathering sound from a device and producing a signal representative of the gathered sound;
conditioning the signal representative of the gathered sound by shifting a first range of frequencies of the sound-representative signal that are outside a defined bandwidth to a different corresponding second range of frequencies that are within that defined bandwidth;
producing audio sound based upon the conditioned sound-representative signal resulting from the conditioning, wherein the produced audio sound has frequencies within the defined bandwidth.

16. A method as recited in claim 15, wherein the producing further comprises digitizing the conditioned sound-representative signal and sending it over a communication medium.

17. A method as recited in claim 15, wherein the producing further comprises digitizing the conditioned sound-representative signal and storing it in a storage medium.

18. A method as recited in claim 15, wherein the conditioning further comprises:
enhancing the low frequencies of the sound-representative signal which is representative of the gathered sound;
mixing the enhanced low frequencies with a carrier frequency; and
filtering the frequencies of the mixed signal.

19. A method as recited in claim 15, wherein the conditioning further comprises:
enhancing the high frequencies of the sound-representative signal which is representative of the gathered sound;
mixing the enhanced high frequencies with a carrier frequency; and
filtering the frequencies of the mixed signal.

20. A method as recited in claim 15, wherein the defined sound bandwidth is within the human hearing range.

21. A method as recited in claim 15, wherein the defined sound bandwidth is a range of sound-representative signals typically transmitted over the telephonic network infrastructure.

22. A method as recited in claim 15, wherein the first range of frequencies is below approximately 400 Hz or above approximately 3400 Hz.

23. A computer-readable medium having computer-executable instructions that, when executed by a computer, performs a method for facilitating acoustics-based diagnosis, the method comprising:
obtaining a signal representative of a conditioned sound, wherein its frequencies fall within a defined sound bandwidth;
de-conditioning the signal representative of a conditioned sound so that frequencies within the defined sound bandwidth are shifted outside of that bandwidth;
acquiring one or more acoustics-based fault-signatures associated with the device;
analyzing the de-conditioned sound-representative signal based upon the one or more acquired fault-signatures.

24. A medium as recited in claim 23, wherein the method further comprises presenting the results of the analyzing.

25. A medium as recited in claim 23, wherein the method further comprises generating a fault-condition indication based upon the results of the analyzing.

26. A medium as recited in claim 23, wherein the method further comprises determining a likelihood of fault conditions based upon the results of the analyzing.

27. A medium as recited in claim 26, wherein the fault condition is a present fault condition.

28. A medium as recited in claim 26, wherein the fault condition is a future fault condition.

29. A medium as recited in claim 23, wherein the defined sound bandwidth is within the human hearing range.

30. A medium as recited in claim 23, wherein the defined sound bandwidth is a range of sound-representative signals typically transmitted over the telephonic network infrastructure.

31. A medium as recited in claim 23, wherein the first range of frequencies is below approximately 400 Hz or above approximately 3400 Hz.

32. A method for facilitating acoustics-based diagnosis, the method comprising:
obtaining a signal representative of a conditioned sound, wherein its frequencies fall within a defined sound bandwidth;
de-conditioning the signal representative of a conditioned sound so that frequencies outside the defined sound bandwidth are shifted inside of that bandwidth;
acquiring one or more acoustics-based fault-signatures associated with the device;
analyzing the de-conditioned sound-representative signal based upon the one or more acquired fault-signatures.

33. A method as recited in claim 32 further comprising presenting the results of the analyzing.

34. A method as recited in claim 32 further comprising generating a fault-condition indication based upon the results of the analyzing.

35. A method as recited in claim 32 further comprising determining a likelihood of fault conditions based upon the results of the analyzing.

36. A method as recited in claim 35, wherein the fault condition is a present fault condition.

37. A method as recited in claim 35, wherein the fault condition is a future fault condition.

38. An acoustics-based diagnostics architecture comprising:
a sound-gatherer configured to gather sound produced by the operation of a device and convert the gathered sound into a sound-representative signal;
a sound-signal-conditioner configured to produce a conditioned sound-representative signal by shifting a first range of frequencies of the sound-representative signal that are outside a defined bandwidth to a different corresponding second range of frequencies that are within that defined bandwidth;
a sound-deconditioner configured to de-condition the signal representative of a conditioned sound so that frequencies outside the defined sound bandwidth are shifted inside of that bandwidth;
a sound-analyzer configured to analyze the signal representative of the de-conditioned sound and determine likelihood of one or more fault conditions of the device;
a fault-signature database interface configured to interface and acquire one or more fault-signatures associated with the device from a database of such;
wherein the analysis of the signal representative of the de-conditioned sound by the sound-analyzer is based upon the one or more fault-signatures acquired from the database.

39. An architecture as recited in claim 38, further comprising a presenter configured to present the results of the analysis of the sound-analyzer.

40. An architecture as recited in claim 38, wherein the fault condition is a present fault condition.

41. An architecture as recited in claim 38, wherein the fault condition is a future fault condition.
